(19) United States
(12) Patent Application Publication
(10) Pub. No.: US 2025/0001646 A1
(43) Pub. Date: Jan. 2, 2025

(54) MACHINE FOR PROCESSING A SLAB WITH REDUCED STRESSES DURING ROUTING AND CUTTING AND RELATED METHOD

(71) Applicant: POSEIDON INDUSTRIES, INC., Punta Gorda, FL (US)

(72) Inventor: Jose Antonio ALVA, North Port, FL (US)

(21) Appl. No.: 18/343,780

(22) Filed: Jun. 29, 2023

(51) Int. Cl. B28D 7/00; B28D 1/00; B28D 1/04; B28D 1/18; B28D 7/04

(52) U.S. Cl. CPC B28D 7/005; B28D 1/003; B28D 1/04; B28D 1/186; B28D 7/046

(57) ABSTRACT

A machine for processing a stone or stone-like slab includes a frame. A bridge extends across a slab processing area and mounted for movement on the frame. A carriage is mounted for movement on the bridge to define movement of a lower end of the carriage along the X, Y and Z coordinate axes. A machine yoke is rotatably mounted at the lower end of the carriage and configured for C-axis rotation. A machining head is rotatably mounted between support arms of the machine yoke and configured for A-axis rotation. The machine yoke is rotated about the C-axis when routing or cutting on the slab. A controller is configured to rotate the machine yoke and maintain a support arm leading along the path of advancement of the finger bit to relieve stress on the A-axis when routing or cutting on the slab.

### FIELD OF THE INVENTION

The present invention relates to the field of stone processing, and more particularly, this invention relates to processing a stone or a stone-like slab by routing or cutting the slab with reduced stresses and associated method.

### BACKGROUND OF THE INVENTION

A stone or stone-like slab is commonly used in building construction. For example, granite, quartz, marble, soapstone, engineered stone, and other quarry stones are often selected for use as flooring, tables, countertops, and kitchen sinks. These stone slabs may also be formed from a combination of natural and synthetic materials and include binders, and have improved qualities and aesthetic characteristics, reproducibility, and stain-resistant or heat-resistant properties. Stone slabs usually have certain features that must be taken into account during processing, which includes cutting and fabrication, especially for counter tops, kitchen sinks, and other end-use applications that require high aesthetic consideration.

For example, the stone slabs may have grain, i.e., vein patterns, that dictate the desired positioning of a countertop or similar product to be cut from the stone. The countertop may be more aesthetically pleasing if the grain pattern extends in a certain direction. Other cut sections from the same or similar stone slab that are arranged in the same location in the home should match the vein pattern.

Cutting the outline of the slab and cutting any sink holes, cut-outs, or other slab details is important and requires precision cutting. Many vendors employ a three axis cutting machine having a circular saw blade. These machines are often used in the industry to cut the outer perimeter of the slab, followed by cutting sink holes using the circular saw blade. The slab outline may be initially cut, and then manually repositioned for sink hole cutting.

Sometimes the cutting tool is a router or finger bit that may be used with repeated cutting passes to gradually cut a sink hole. This is a slow process since repeated passes are made with each router pass making a deeper cut into the slab. To alleviate the slow processing time associated with normal finger bit cutting, the circular saw blade is employed instead of a router bit, but even then there are usually issues with circular blade cutting since it may not be possible to make accurate deep cuts since the blade runs into the table surface during cutting, creating friction, drag and heat. Even if a router or finger bit is used on a multiple axis machine, usually the stresses are increased on the different axes of movement if deep cuts are made with a router or finger bit. For this reason, sink hole cutting on stone slabs and similar slab cutting is challenging when the aesthetic considerations of the slab are taken into consideration and accurate and clean cuts are required, without unduly slowing the slab processing into a finished product.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

In general, a machine for processing a stone or stone-like slab may comprise a frame having vertical supports and guide rails. The frame may define a slab processing area in which a slab to be processed extends along an X and Y coordinate axis. A bridge may extend across the slab processing area and be mounted for movement along the guide rails. A carriage may be mounted on the bridge and configured for vertical movement along a Z coordinate axis and horizontal movement on the bridge to define movement of a lower end of the carriage along the X, Y and Z coordinate axes.

A machine yoke may be rotatably mounted at the lower end of the carriage and configured for C-axis rotation. The machine yoke may comprise opposing support arms. A machining head may be rotatably mounted between the support arms and configured for A-axis rotation. The machining head may comprise a spindle drive and spindle connected thereto. The spindle may be configured to mount a finger bit for routing a sink hole or cutting on the slab. A first actuator may be carried by the carriage and connected to the machine yoke and configured to rotate the machine yoke about the C-axis when routing or cutting on the slab. A controller may be connected to the spindle drive and first actuator and configured to rotate the machine yoke and maintain a support arm leading along the path of advancement of the finger bit to relieve stress on the A-axis when routing or cutting on the slab.

The controller may be configured to periodically rotate the machine yoke 180 degrees so that the other support arm is leading along the path of advancement of the finger bit when routing or cutting on the slab. At least one shaft may be connected to the machining head and axial with the A-axis and supported by at least one of the support arms of the machine yoke. A second actuator may be connected to the at least one shaft and controller. The second actuator may be configured to rotate the machining head along the A-axis into a bevel routing or cutting position on the slab. A third actuator may be supported by the frame and connected to the bridge and carriage and the controller. The third actuator may be configured to drive the bridge and carriage during routing or cutting on the slab. The third actuator may comprise a first motor supported by the frame and connected to the controller and bridge and configured to drive bridge movement on the frame, and a second motor may be supported by the bridge and connected to the controller and carriage and configured to drive carriage movement on the bridge.

A work table may be positioned at the slab processing area, and vacuum pods may be positioned on the work table. The vacuum pods may be configured to support a top polished face of a slab for upside down routing or cutting. The work table may comprise a milled and polished work surface. The spindle at the machining head may be configured to mount a circular saw blade. The machining head may be configured to be rotated up to 90 degrees along the A-axis to permit circular saw blade cutting.

A method of processing a stone or stone-like slab may comprise providing a frame having vertical supports and guide rails, the frame defining a slab processing area in which a slab to be processed extends along an X and Y coordinate axis. The method includes moving a bridge across the slab processing area and mounted for movement along the guide rails, moving a carriage on the bridge and configured for vertical movement along a Z coordinate axis and horizontal movement on the bridge to define movement of a lower end of the carriage along the X, Y and Z coordinate axes, rotating a machine yoke at the lower end of the carriage and configured for C-axis rotation, the machine yoke comprising opposing support arms, and moving a machining head between the support arms and configured for A-axis rotation, the machining head comprising a spindle drive and spindle connected thereto, the spindle configured to mount a finger bit. The method further includes routing a sink hole or cutting on the slab using the finger bit, and rotating the machine yoke about the C-axis and maintaining a support arm leading along the path of advancement of the finger bit to relieve stress on the A-axis when routing or cutting on the slab.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a schematic, isometric view of the machine for processing a slab with reduced stresses during routing and cutting in accordance with a non-limiting example.

FIGS. 2-5 are schematic, isometric views of the machining head at different stages of finger bit routing a sink hole on the slab and showing a support arm leading along the path of advancement of the finger bit to relieve stress on the A-axis.

FIG. 6 is another schematic, isometric view of the machine for processing a slab similar to that shown in FIG. 1, but showing the machining head rotated along the A-axis into a bevel routing or cutting position.

FIG. 7 is yet another schematic, isometric view of the machine similar to FIGS. 1 and 6 and showing the machining head mounting a circular saw blade to cut a slab that has been aligned for upside down cutting in a slab cutting position.

FIG. 8 is a high-level flow diagram of a method of processing the slab using the machine of FIG. 1.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

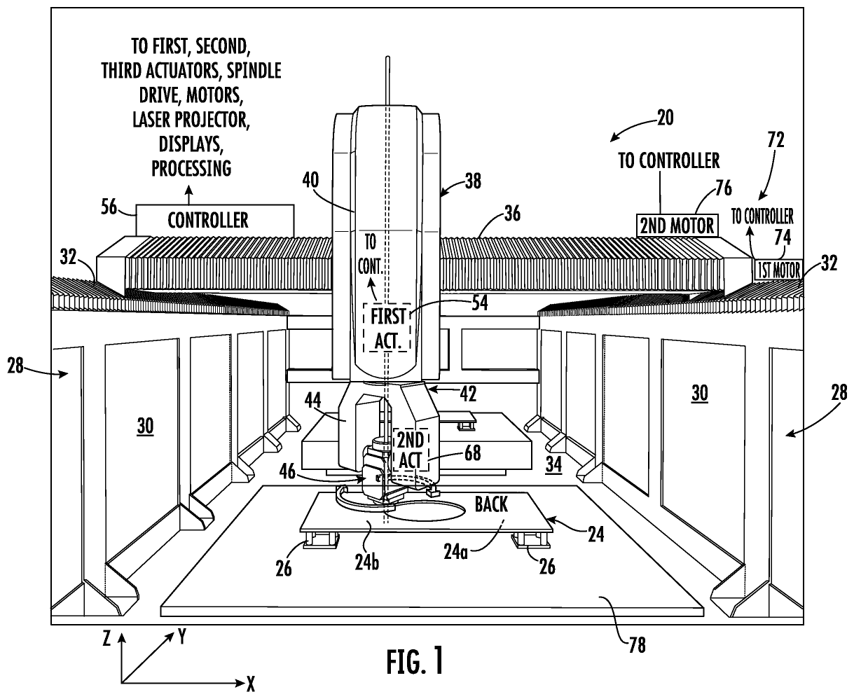

Referring now to FIG. 1, there is illustrated generally at 20 a machine, in accordance with a non-limiting example, for processing a stone or stone-like slab illustrated generally at 24, showing its finished or polished face 24a corresponding to the top polished face down and resting on vacuum pods 26. The machine 20 includes a frame 28 having vertical supports 30 formed as two opposing side walls and guide rails 32 located on the top portion of the frame defined by the vertical supports. The frame 28 defines a slab processing area 34 in which a slab 24 to be processed extends along an X and Y coordinate axis.

A bridge 36 extends across the slab processing area 34 and is mounted for movement along the guide rails 32 so that the bridge may traverse across the slab processing area. A carriage 38 is mounted on the bridge 36 and includes a vertically extending housing 40 configured not only for vertical movement along a Z coordinate axis, but also for horizontal movement on the bridge to define movement at a lower end of the carriage along the X, Y and Z coordinate axes. A machine yoke 42 is rotatably mounted at the lower end of the carriage 38 and configured for C-axis rotation as illustrated by the horizontal direction of the rotating arrow in FIG. 1. Rotation may be clockwise or counterclockwise, of course. The machine yoke 42 includes opposing support alarms 44 such that the machine yoke is similar to an inverted U. A machining head 46 is rotatably mounted between the support arms 44 and configured for A-axis rotation. The machining head 46 includes a spindle drive 48 and spindle 50 connected thereto shown diagrammatically in the machine head (FIG. 3). In this example, the spindle 50 is configured to mount a router bit, e.g., finger bit 52, for routing a sink hole or perform other similar cutting on the slab 24.

As illustrated in FIG. 1, the machining head 46 is vertically oriented so that the spindle 50 is oriented along the Z-axis so that any router or finger bit 52 is perpendicular to the plane of the slab 24 that extends along the X and Y coordinate axis. A first actuator 54 is carried by the carriage 38 within its housing 40 and connected to the machine yoke 42 and configured to rotate the machine yoke 42 about the C-axis when routing or cutting on the slab 24. A controller 56 is connected to the spindle drive 48 and the first actuator 54 and configured to drive the first actuator and rotate the machine yoke 42 and maintain a support arm 44 leading along the path of advancement of the router or finger bit 52 to relieve stress on the A-axis when routing or cutting on the slab 24.

At least one shaft 58 (FIG. 3) is supported by at least one of the support arms 44 and axial with the A-axis. The shaft 58 may operate as a support to the machining head 46. The machining head 46 is connected to the at least one shaft 58. In an example, a larger gear unit 60 is positioned on one side and the shaft 58 on the other side and rotatably mounted between the support arms 44 and configured for A-axis rotation about the shaft and gear unit. Thus, by rotating the machine yoke 42 during the routing and cutting, and maintaining a support arm 44 leading along the path of advancement of the finger bit 52, stresses are relieved on the A-axis during the routing or cutting operation of the slab 24. The controller 56 may be pre-programmed for the exact cutting or routing path on the slab 24 based upon the desired configuration of a sink hole and/or countertop.

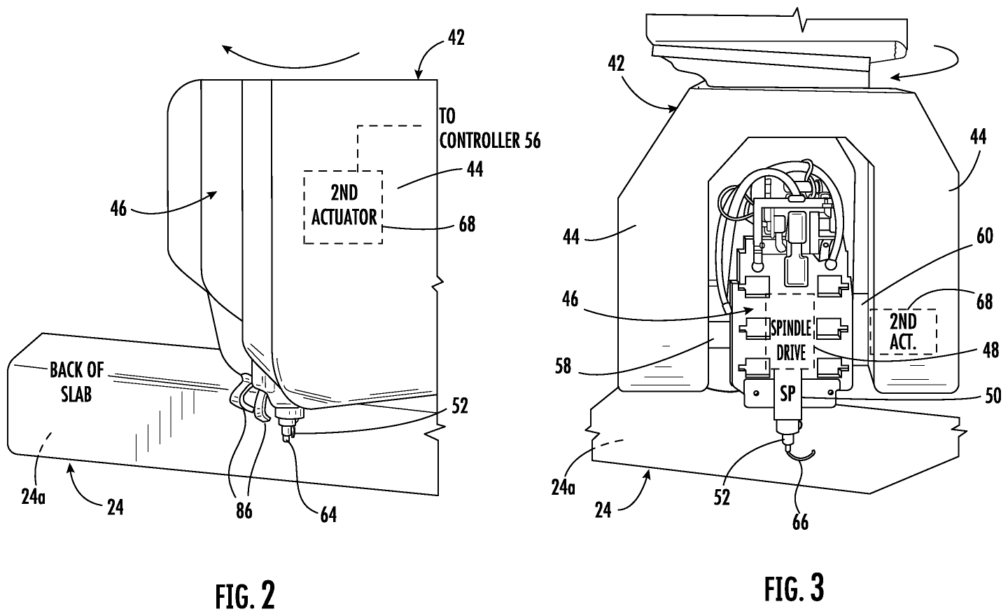

Referring now to FIGS. 2-5, there are illustrated schematic, isometric views of the machine yoke 42 with its support arms 44 and machining head 46 at different stages of finger bit 52 routing a sink hole on the slab 24. As illustrated, a support arm 44 is always leading along the path of advancement of the finger bit to relieve stress on the A-axis such as defined by the shaft 58 and gear unit 60 or other components mounting the machining head for rotation about the A-axis.

As shown in FIG. 2, the router or finger bit 52 cut is initially made by lowering the carriage 38 that mounts the machine yoke 42 and machining head 46 into the initial routing or cutting position. The initial hole 64 is drilled (or routed) such as corresponding to the interior of the sink hole. The finger bit 52 may be different diameters depending on the sink hole configuration, but the initial cut or hole is made and cutting progresses along the cut line or cut path 66 designed for the sink hole. In an example, the finger bit 52 may be an engineered finger bit such as a 40 millimeter and operate at about 5,500 to 6,000 rpm in an example with feed rates at more than 15 to 20 inches per minute. The finger bit 52 may be a diamond tool, including in an example a one inch, 35 mm straight finger bit. Another example includes an 8-segment high-speed finger bit 52. Different binders may be used, with a soft binder having a bigger cut potential. Other finger bit 52 configurations may be used.

As the routing or cutting continues as shown in FIG. 3, and shown by the initial rout or cut path 66, the machine yoke 42 is rotated about its C-axis to always maintain a support arm 44 leading along the path of advancement of the finger bit 52 to relieve stress on the A-axis during the routing or cutting operation.

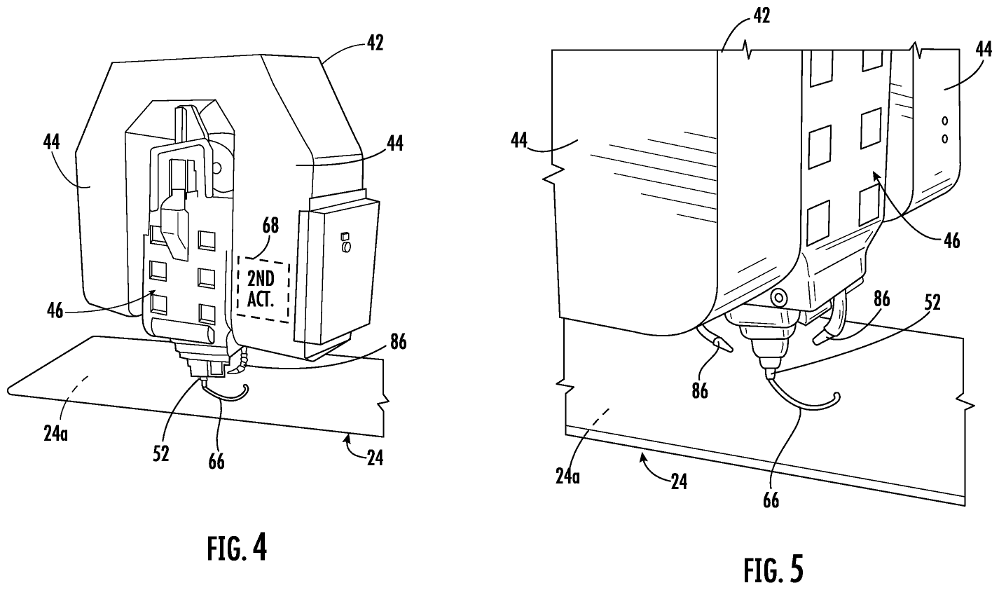

As shown in FIG. 4, the machine yoke 42 continues its rotation to reach a point as shown in FIG. 5 where the cut path 66 is continued in a direction almost 90° from the initial cut path. Depending on the configuration of the sink hole to be formed, the support arm 44 may lead in a straight direction for a predetermined distance and then turn as shown in FIG. 5, where portions of the cut path 66 are straight and then follow with a gentle 90° turn, but with stresses always relieved on the A-axis with a helicoidal movement.

During the routing or cutting, the controller 56 may be configured to periodically rotate the machine yoke 180° so that the other opposing support arm 44 is leading along the path of advancement of the finger bit 52 when routing or cutting on the slab 24. This aids in relieving stress along the same axial direction on the shaft 58, such as any motors, actuators, drive shafts, and gear unit 60 to equal out over time the various stresses imposed on machine components that are in the machining head 46 along the A-axis and along the shaft and gear unit.

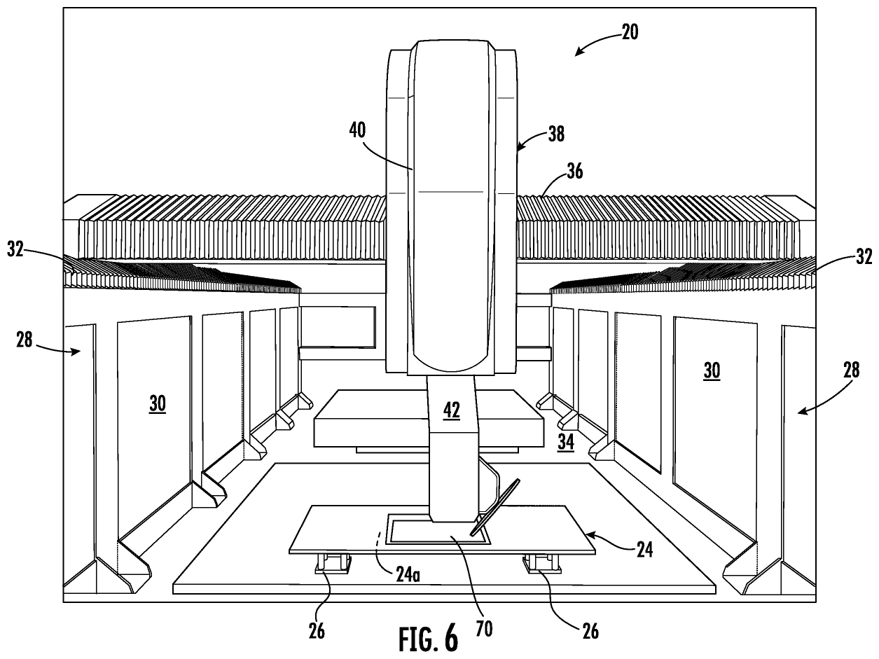

A second actuator 68, such as an electric drive motor, may be connected to the at least one shaft 58 and/or gear unit 60 and controller 56. The second actuator 68 may be configured to rotate the machining head 46 along the A-axis into a bevel routing or cutting position on the slab, such as shown in FIG. 6, where a sink hole 70 is being cut on a bevel. The slab 24 may be used to form a farm sink, for example, with the bevel out to permit adhesion of the sink. The first and second actuators 54,68 may be formed as electric motors that include appropriate drive mechanisms. In the example of the first actuator 54, an electric motor may be connected to a gear mechanism (not shown) that rotates the machine yoke 42 about the C-axis and could include a stepper motor or other controlled movement mechanism. The second actuator 68 may also be formed as an electric motor that may be mounted in one of the support arms 44 and connected to the shaft 58 or gear unit 60 in a non-limiting example and configured to rotate the shaft and the machining head, or mounted within the machining head 46 in an example. Again, different drive units, stepper motors or other drive mechanisms may be used. The spindle drive 48 also may include an electric motor with an appropriate drive mechanism configured to rotate the spindle 50 at high speeds for routing and cutting.

A third actuator mechanism 72 may be supported by the frame 28 and connected to the bridge 36 and carriage 38 and the controller 56 and configured to drive the bridge and carriage during routing or cutting on the slab 24. The third actuator mechanism 72 may include a first motor 74 supported by the frame 28 and connected to the controller 56 and bridge 36 and configured to drive bridge movement on the frame. A second motor 76 may be supported by the bridge 36 and connected to the controller 56 and carriage 38 and configured to drive carriage movement on the bridge. Various drive mechanisms may include different actuators, including different motors or servomotors or other appropriate drive mechanisms to maintain exact positioning and control. Positioning sensors and feedback sensors may be located on different components to aid in exact positioning within thousandths of an inch, including on the guide rails 32, frame 28, bridge 36, carriage 38, and other components, including the spindle drive 48 and any actuators and motors 54, 68, 72, 74, 76.

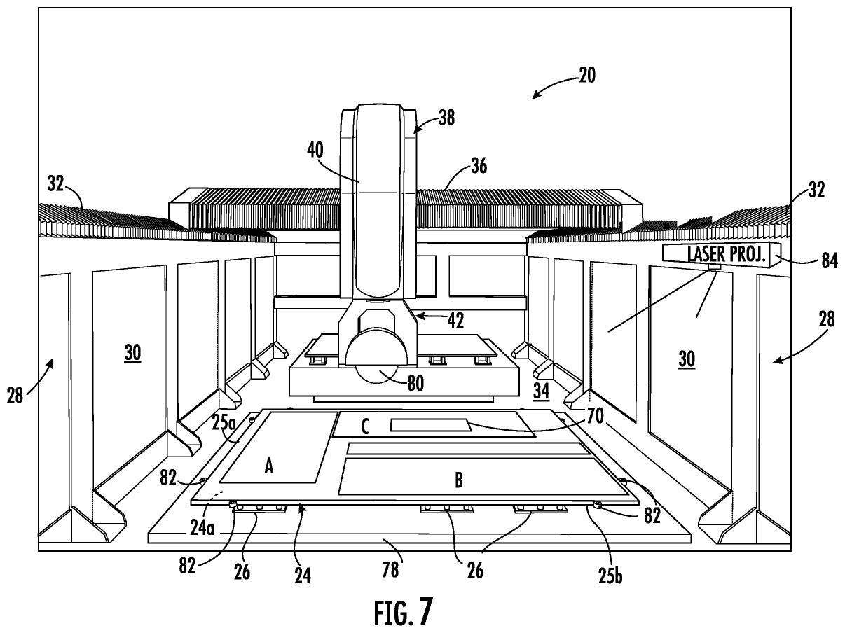

A work table 78 is positioned at the slab processing area 34 and the vacuum pods 26 are positioned on the work table. The vacuum pods 26 are configured to support the top polished finished face 24a of the slab upside down for routing or cutting on the rear side 24b of the slab 24. The work table 78 may include a milled and polished work surface, and in an example, two work tables may be positioned within the slab processing area 34. In the example as shown in FIG. 7, the machining head 46 may be configured to mount a circular saw blade 80 and configured to be rotated up to 90° along the A-axis as compared to the configuration shown in FIG. 1 to permit circular saw blade cutting as will be explained below. The circular saw blade 80 is also shown in a bevel cutting position of FIG. 6.

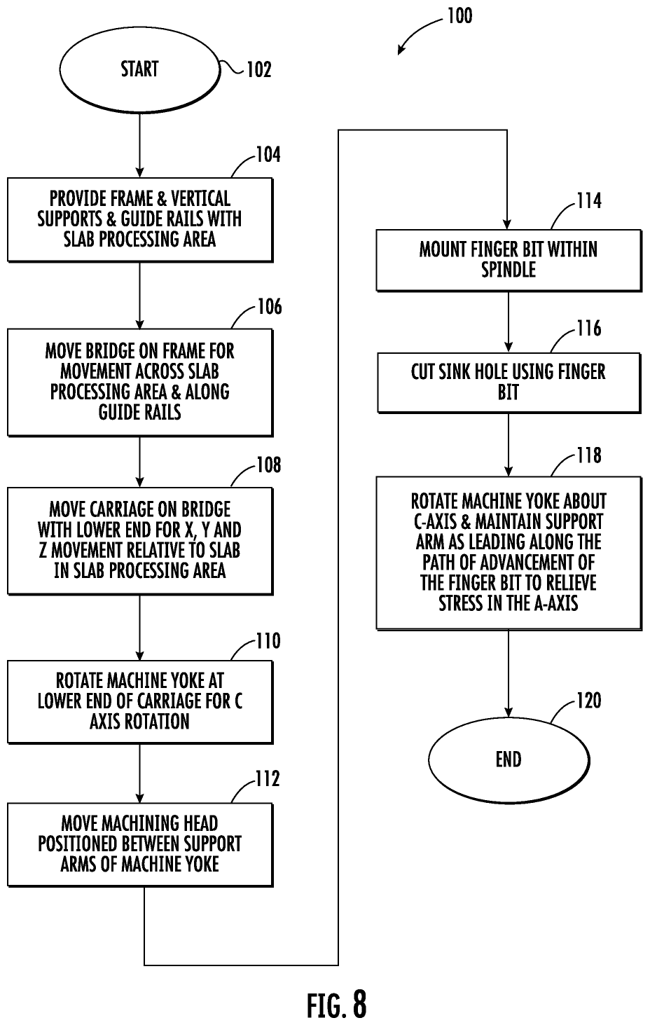

Referring now to FIG. 8, there is illustrated generally at 100 a high-level method for processing the stone or stone-like slab 24 as shown in FIG. 1, which includes initial making of the machine. The method starts (Block 102) and a frame 28 is provided having vertical supports 30 and guide rails 32. The frame 28 defines a slab processing area 34 in which a slab 24 to be processed extends along an X and Y coordinate axis (Block 104). A bridge 36 is moved across the slab processing area 34 and mounted for movement along the guide rails 32 (Block 106). A carriage 38 is moved on the bridge 36 and configured for vertical movement along the Z coordinate axis and for horizontal movement on the bridge to define a movement of the lower end of the carriage along the X, Y and Z coordinate axes (Block 108). A machine yoke 42 is rotated at the lower end of the carriage 38 and configured for C-axis rotation. The machine yoke 42 includes opposing support arms 44 (Block 110). A machining head 46 is moved between the support arms 44 and configured for A-axis rotation and includes a spindle drive 48 and spindle 50 connected thereto (Block 112). The spindle 50 mounts a finger bit 52 (Block 114). A sink hole 70 is cut by routing using the finger bit 52 (Block 116). The machine yoke 42 is rotated about the C-axis and a support arm 44 maintained as leading along the path of advancement of the finger bit 52 to relieve stress in the A-axis when routing or cutting on the slab 24 (Block 118). The process ends (Block 120).

As noted above, the slab 24 is positioned upside down for cutting and positioned on the vacuum pods 26. Mirror images are used to position the slab for correct cutting and routing. The slab 24 has a top polished or finished face 24a and a bottom surface 24b with the bottom surface facing up and finished face down as shown in FIGS. 1-7. Reference is made to the process described in U.S. patent application Ser. No. 18/327,101 filed Jun. 1, 2023, the disclosure which is hereby incorporated by reference in its entirety.

An imaging device, such as a display of a computer or other processing device, may be configured to receive and display a digital image of the top polished face 24a of the slab 24. When first processed, the slab 24 has rough uncut side edges, and in an example, is a quarried slab roughly cut into a substantial rectangular pattern, which is to be cut, and has opposing short sides 25a and opposing long sides 25b in this example (FIG. 7). The slab 24 in this example is about 2.0 to 3.0 centimeters thick, and in another example, about 1.25 to 1.5 inches thick. A plurality of reference markers 82 are adhered on at least one side edge of the slab 24 and shown as the cylindrically shaped markers in FIG. 7.

In the example of FIG. 7, at least one long side 25b includes at least two adhered reference markers 82 and at least one short side 25a includes at least one adhered reference marker, but as illustrated, includes two adhered reference markers 82 on each side. Each of the adhered reference markers 82 are the thickness of the slab 24 and each have a top end and a bottom end flush with the respective top polished face 24a and bottom surface 24b. Each reference marker 82 may be formed as a cylindrically shaped foam element to allow contraction and expansion back to normal size if the markers are pressed when the slab is moved.

A slab digital image may be obtained from a camera connected to the controller 56 or other processor, which takes a photographic image of the slab 24 to be laid out and cut. The reference markers 82 may be adhered by a preferred waterproof adhesive to the edge of the slab 24 as illustrated before the camera generates the image in order to obtain a digital image of the top polished face 24a of the slab, together with the reference markers 82. The digital image will show the locations of the adhered reference markers 82 on the long side 25b and short side 25a based upon the configuration of the rough generally uncut side edges. It should be understood that the machine 20 with its associated system as described for slab alignment may be used even when the slab 20 and side edges 25a, 25b are accurately cut straight edges.

The stone slab 24 may include a surface appearance as a grain pattern produced by veins that are matched when a slab cut layout is generated, such as by a CAD program using a program, such as Slabsmith, that is based on how the slab will be cut, such as for a countertop, table, floor, or other use. The slab 24 may be formed from different slab materials including granite, marble, quartz, soapstone, and other quarried materials or engineered stone and hybrid or combinations of synthetic and stone material held together by a resin binder, for example.

The controller 56 receives a digital image of the slab 24 and its top polished face 24a and forwards the digital image data to an imaging device as a display, and via user input on a keyboard, mouse, etc., the controller via software overlays a slab cut layout on a digital image of the top polished or finished face 24a. For example, there may be a large rectangular outline corresponding to the rectangular slab to be cut from the rough cut slab 24 and the other lines may correspond to the kitchen components such as a sink cut-out 70 as shown in FIG. 7. Other components can be laid out and cut. The controller 56 via its CAD or other software may generate a digital slab layout file that contains digital data representative of the top polished face 24a and it slab cut layout referenced to the top end of the adhered reference markers 82. The digital slab image file may be a vector file such as a CAD file, and in an example, a Drawing Exchange Format (DXF) file.

The reference markers 82 may be traced by the CAD feature of the layout software and show up as a DXF file layout. The DXF format may be exported and mirror imaged so that the reference markers 82 are positioned in mirror imaged locations corresponding to when the top polished face 24a of the slab 24 is in a reverse or upside down position for cutting with the top polished face down and cutting occurring on the bottom surface 24b. The sink cut-out or sink hole 70 and labeled sections A, B and C are reversed and are shown in FIG. 7. The controller 56 is connected to a laser projector 84 (FIG. 7) showing the CNC slab processing machine 20 as a cutting/fabrication machine. The mirror imaged locations of the reference markers 82 are projected as digital data by the controller 56 to the laser projector 84 where they are projected as green light in an example at the location on the machine 20 where the actual adhered reference markers 82 are to be located by aligning the bottom ends of the adhered reference markers with the respective projected reference marker locations when the slab 24 is upside down for cutting in a slab cutting position on the vacuum pods 26 positioned on the work table 78.

It should be understood that the reference markers 82 formed from the cylindrically shaped foam elements in this example may be any diameter, but typically are the same length as the thickness of the stone slab 24 so either end of the foam piece is flush with the respective surfaces 24a, 24b of the stones slab. At the very least, there should be two reference markers 82 on one of the long sides 25b, such as the top long side, and one reference marker on either of the short sides 25a. The reference markers 82 as foam elements may be adhered to the side edges by a waterproof adhesive or similar adhesion technique, and are adhered before a photo image of the slab is taken to generate any slab cut layout. The reference markers 82 will appear in any images as circles and may be traced by a CAD feature of any layout software.

In this example, the reference markers 82 may show up on a DXF file layout produced from the Slabsmith-type software and CAD features. When these files are used for execution on the machine 20 as a cutting/fabrication machine, the location of the reference markers 82 are mirror imaged and their locations are highlighted and projected via the laser projector 84. Because the slab 24 is upside down with the top polished face 24a down and bottom surface 24b up for cutting, the only visible references for positioning the slab will be the laser indicating the proper location where the bottom surface of the cylindrical foam reference marker 82 on the actual physical slab are to be located, and thus, enable exact positioning of the slab for cutting upside down in the proper slab cutting position.

The machine 20 has a work surface as a work table 78 on which the slab 24 is positioned upside down on the vacuum pods 26 with respect to the mirror imaged digital slab layout file. In this example, the work surface as a work table 78 supports the vacuum pods 26 on which the top polished face 24a of the slab 24 is positioned for upside down cutting. An example of the vacuum pods 26 is shown in FIGS. 1, 6 and 7. The upside down cutting of the slab 24 occurs on the vacuum pods 26 and exact positioning is required.

The work surface as a work table 78 may be formed as a polished or engineered stone slab such as a quartz slab that has been milled to a flat polished surface and a precise dimension on its surface for CNC cutting and fabrication of a stone slab 24. In an example, the work table 78 may be formed from a quartz slab having a top surface that is substantially level along the Z axis. The vacuum pods 26 are positioned on the work table 78 and the vacuum pods provide a safe and secure holding system for the stone slab, and thus, do not require a fabricator to drill into the slab 24 or work around the edges of a countertop. In this example, the vacuum pods 26 are rectangular configured and include vacuum ports and vulcanized rubber fused onto an anodized aluminum surface with a tolerance of +/−0.02 millimeters. The slab 24 may be raised from the work table 78 on the vacuum pods 26 in order to cut, route, drill, cut and machine and polish edges. The friction pads on the vacuum pods 26 as noted before may be made from hot vulcanized rubber fused onto an anodized aluminum surface to endure the harsh and demanding industrial requirements of stone slab cutting. The heights of the vacuum pods 26 may vary, but generally will raise the slab 24 at least a few inches off the work table 78.

For cutting stone, the cutting blade as a circular saw blade 80 may be formed from ceramic or similar materials. A coupling cone may be configured to mount the cutting blade 80 to the spindle 50. Tools for cutting, routing, polishing, etc. may be interchanged as the tools may be mounted on different coupling cones.

The machine 20 may be formed as a slab cutting and fabrication machine, such as a five axis CNC machine sold by Poseidon Industries, Inc. as the T-REX. This CNC fabrication center may operate as a 5 or 4 axis CNC bridge saw. Slab pieces may be moved around with vacuum lifters. It may also operate as a 5 axis CNC profiling machine and sculpting machine. It has an automatic tool changer for profiling tools and saw attachment. It includes a 25 horsepower to 35 horsepower spindle depending on configuration and operates with an 18 inch to 20 inch blade with a blade attachment for a 20 inch blade diameter. It may include a 20 tool magazine and is an available in single and dual table models. In FIGS. 1, 6 and 7, dual work tables 78 are illustrated. In the configuration with a 35 horsepower motor and 20 inch blade, the X-axis is about 160 inches and the Y-axis is about 100 inches. The air may have continuous 125 pounds per square inch at about 10 cubic feet per minute. Water line capacity for clean water is 1 to 2 gallons per minute to aid in cooling and debris removal during cutting via water spray nozzles 86 as shown in FIGS. 2-5. A capacity water line ready with recycled water may be 4 to 6 gallons per minute. The machine weight is about 17,000 pounds and uses 400 volts with mutual 80 amp three-phase power.

All cuts and routing and subsequent polishing occur while the slab 24 is positioned on the vacuum pods 26 with the slab in an upside down position. The laser projector 84 (FIG. 7) not only projects the locations for alignment of the reference markers 82 and the slab 24 for cutting, routing and polishing, but may be used in an example to help guide the machine head 46, also referred to as a cut head. The laser projector 84 may be mounted above the work table 78 and may employ a green or red light laser that is controlled via the controller 56.

The laser projector 84 may include thermal management for temperature stability and include fiber-coupled lasers with red and/or green laser source having an output power that varies and may range up to 14 milliwatts and a conventional output power of about 7 milliwatts. It may have a focus range from about 0.5 meters to 7.0 meters and a working distance using a tele-optic up to about 14 meters. Different cooling options may be available such as an air hose or water cooling system. The green light laser, which is preferred, has greater variability than red light laser. The fan angle can range from 80° by 80° and with tele-optic about 60° by 60°. Accuracy may be about 0.25 millimeters per meter with the focus range from about 0.5 meters up to about 7.0 meters as a standard focus, and in an example, about up to 14 meters in some examples. Operating voltages may vary, and in an example, be about 24 volts DC. The laser projector 84 may include different interfaces such as Ethernet TP, 100 based TX or RS-232 or other interfaces.

The laser projector provides for quick and accurate alignment of a slab 24 and the laser projector may show the cut edges of a slab on the basis of complex construction files on the original scale with slabs optimally aligned on the vacuum pods 26 and work table 78 using slab contours. The laser projector 84 may be used with dual work tables 78, such as shown in FIGS. 1, 6 and 7. The contours of a finished workpiece may be projected on the slab 24. Different CNC formats may be supported using different laser protecting software, such as DXF, where contours may be transferred directly to the laser via the controller 56 and its machine control. Interface communication connections may include the RS232, optical fiber, RS485, or other network connections such as IPX/XPF, TCB/IP with each session able to control multiple projectors, if needed. The laser projector 84 may be mounted at different locations on the frame 28 to ensure a line laser covers the entire work table 78, including dual tables 38. It can be mounted on a rotatable block mount and even on the bridge 36 or carriage 38. Wavelengths may vary from about 635 nanometers to about 830 nanometers, and in another example, from about 405 nanometers to 830 nanometers or other ranges therebetween.

The controller 56 may be a computer system that processes data in accordance with one or more instructions and includes one or more processors and memory such as both RAM and ROM for storing data. The controller 56 may be a personal computer, high end workstation, a mainframe, server, or cloud based system in non-limiting examples. The controller 56 may be several computers controlling respective individual motors, etc. The controller 56 not only controls the different electric motors, actuators, and servomotors and other machine components, but also processes digital images using an appropriate CAD program, including for example, Slabsmith, and may process image data and issue commands to the machine 20.

The controller 56 may include an image data conversion program as software that converts image data such as the CAD DXF file, in an example, into the appropriate control signals for instructing the CNC slab processing machine 20 to move the machining head 46 in the appropriate directions along the five X, Y, Z, A and C axes. It is possible that externally-generated digital image files may be stored in a memory of the controller 56. Other image files may be transmitted to the controller 56 via a local area or wide area network and wired or wireless connections or via other internet routes.

The CAD program may store data in layers and blocks of data that include not only a countertop outline, but an outline for a sink opening, faucet cut-outs, sink holes, and other structures and features in a countertop. In order to ensure proper positioning and cutting, the CNC processing machine 20 includes the smooth work surface on which the slab 24 is positioned upside down on the vacuum pods 26, such as an accurately milled, engineered, and polished quartz or other surface. Similar processing used for the slab 24 may be used to produce the flat polished surface of the work table 78.

Images of different slabs 24, including the top polished faces 24a with different aesthetic vein characteristics of different slabs may be stored within a database associated with the controller 56. Different slab cut layout files may be stored, several for an individual slab 24. The digital image of a top polished face 24a of the slab 24 may include dimensional and material details about the stone slab and data related to its storage, including a unique identifier, the date/time it was stored, the dimensional relationships, including the thickness, length and width as a rough cut slab, color characteristics, possible purchaser information, and other customer and commercial data related to the slab.

Any camera used to take a digital image of the slab 24, including the top polished face 24a of the slab and adhered reference markers 82, may be incorporated into a manufacturing line and may even be taken when the slab is positioned off-table from the CNC slab processing machine 20. The camera may be a visible light camera, infrared camera, 3D scanning device, time-of-flight camera, structured light scanner, or stereoscopic scanner. The camera may make 2D and 3D images.

Any imaging device as a display may include a user interface menu that allows user selection via a mouse or other input device, including a keyboard, to toggle between different viewing angles or vantage points and input data related to the slab and cut layouts. The stone slab 24 may be a molded stone slab or formed from particulate mineral material that may be mixed with pigments and a resin binder and compressed to form a hardened slab. The stone slab may be cut to specific shapes for a countertop, table, floor, or similar end uses. The aesthetic effect of the top polished face 24a includes the veins that may extend the complete length of the stone slab and through all or part of the thickness of a stones slab, and provide the natural vein appearance even when the slab is cut and edged to specific shapes.

An initial digital image of the slab 24, such as its top polished face 24a, will show the perceptible characteristics and veins. Different unique identifiers for a stone slab may include a label, bar code, RFID tag, QR code, or etching and writing directly on the stone slab an identifier. Any digital image of the stone slab 24 may have a predetermined dimensional relationship and the ratio of stone slab unit lengths per image pixel may extend less than 0.001 inch per pixel up to 0.02 inch per pixel. This small pixel ratio may allow a distortion free image to be shown. Thus, a digital image of the top polished face 24a may provide a reliable image and tool to overlay a slab cut layout on the digital image and provide a known relationship that facilitates a high degree of precision for slab visualization when generating the slab cut layout.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A machine for processing a stone or stone-like slab, comprising:
a frame having vertical supports and guide rails, the frame defining a slab processing area in which a slab to be processed extends along an X and Y coordinate axis;
a bridge extending across the slab processing area and mounted for movement along the guide rails;
a carriage mounted on the bridge and configured for vertical movement along a Z coordinate axis and horizontal movement on the bridge to define movement of a lower end of the carriage along the X, Y and Z coordinate axes;
a machine yoke rotatably mounted at the lower end of the carriage and configured for C-axis rotation, said machine yoke comprising opposing support arms;
a machining head rotatably mounted between the support arms and configured for A-axis rotation, said machining head comprising a spindle drive and spindle connected thereto, said spindle configured to mount a finger bit for routing a sink hole or cutting on the slab;
a first actuator carried by the carriage and connected to the machine yoke and configured to rotate the machine yoke about the C-axis when routing or cutting on the slab; and
a controller connected to the spindle drive and first actuator and configured to rotate the machine yoke and maintain a support arm leading along the path of advancement of the finger bit to relieve stress on the A-axis when routing or cutting on the slab.

2. The machine of claim 1 wherein said controller is configured to periodically rotate the machine yoke 180 degrees so that the other support arm is leading along the path of advancement of the finger bit when routing or cutting on the slab.

3. The machine of claim 1 comprising at least one shaft connected to the machining head and axial with the A-axis and supported by at least one of the support arms of the machine yoke.

4. The machine of claim 3 comprising a second actuator connected to the at least one shaft and controller, said second actuator configured to rotate the machining head along the A-axis into a bevel routing or cutting position on the slab.

5. The machine of claim 1 comprising a third actuator supported by the frame and connected to the bridge and carriage and said controller, said third actuator configured to drive the bridge and carriage during routing or cutting on the slab.

6. The machine of claim 5 wherein said third actuator comprises a first motor supported by the frame and connected to the controller and bridge and configured to drive bridge movement on the frame, and a second motor supported by the bridge and connected to the controller and carriage and configured to drive carriage movement on the bridge.

7. The machine of claim 1 comprising a work table positioned at the slab processing area, and vacuum pods positioned on the work table, said vacuum pods being configured to support a top polished face of a slab for upside down routing or cutting.

8. The machine of claim 7 wherein said work table comprises a milled and polished work surface.

9. The machine of claim 1 wherein said spindle at said machining head is configured to mount a circular saw blade, said machining head being configured to be rotated up to 90 degrees along the A-axis to permit circular saw blade cutting.

10. A machine for processing a stone or stone-like slab having a top polished face, comprising:
a frame having vertical supports and guide rails, the frame defining a slab processing area in which a slab to be processed extends along an X and Y coordinate axis;
a work table positioned at the slab processing area, said work table comprising a milled and polished work surface;
vacuum pods positioned on the work surface of the work table, said vacuum pods being configured to support the top polished face of the slab for upside down routing or cutting;
a bridge extending across the slab processing area and mounted for movement along the guide rails;
a carriage mounted on the bridge and configured for vertical movement along a Z coordinate axis and horizontal movement on the bridge to define movement of a lower end of the carriage along the X, Y and Z coordinate axes;
a machine yoke rotatably mounted at the lower end of the carriage and configured for C-axis rotation, said machine yoke comprising opposing support arms and at least one shaft supported by at least one of the support arms and axial with the A-axis;
a machining head connected to said at least one shaft and rotatably mounted between the support arms and configured for A-axis rotation about the shaft, said machining head comprising a spindle drive and spindle connected thereto, said spindle configured to mount a finger bit for routing a sink hole or cutting on the slab;
a first actuator carried by the carriage and connected to the machine yoke and configured to rotate the machine yoke about the C-axis when routing or cutting on the slab; and
a controller connected to the spindle drive and first actuator and configured to rotate the machine yoke and maintain a support arm leading along the path of advancement of the finger bit to relieve stress on the A-axis when routing or cutting on the slab.

11. The machine of claim 10 wherein said controller is configured to periodically rotate the machine yoke 180 degrees so that the other support arm is leading along the path of advancement of the finger bit when routing or cutting on the slab.

12. The machine of claim 10 comprising a second actuator supported by the machine yoke and connected to the at least one shaft and controller, said second actuator configured to rotate the machining head along the A-axis into a bevel routing or cutting position on the slab.

13. The machine of claim 10 comprising a third actuator supported by the frame and connected to the bridge and carriage and said controller, said third actuator configured to drive the carriage during routing or cutting on the slab.

14. The machine of claim 13 wherein said third actuator comprises a first motor supported by the frame and connected to the controller and bridge and configured to drive bridge movement on the frame, and a second motor supported by the bridge and connected to the controller and carriage and configured to drive carriage movement on the bridge.

15. The machine of claim 10 wherein said spindle at said machining head is configured to mount a circular saw blade, said machining head being configured to be rotated up to 90 degrees along the A-axis to permit circular saw blade cutting.

16. A method of processing a stone or stone-like slab, comprising:
providing a frame having vertical supports and guide rails, the frame defining a slab processing area in which a slab to be processed extends along an X and Y coordinate axis;
moving a bridge across the slab processing area and mounted for movement along the guide rails;
moving a carriage on the bridge and configured for vertical movement along a Z coordinate axis and horizontal movement on the bridge to define movement of a lower end of the carriage along the X, Y and Z coordinate axes;
rotating a machine yoke at the lower end of the carriage and configured for C-axis rotation, said machine yoke comprising opposing support arms;
moving a machining head between the support arms and configured for A-axis rotation, said machining head comprising a spindle drive and spindle connected thereto;
mounting a finger bit to the spindle;
routing a sink hole or cutting on the slab using the finger bit; and
rotating the machine yoke about the C-axis and maintaining a support arm leading along the path of advancement of the finger bit to relieve stress on the A-axis when routing or cutting on the slab.

17. The method of claim 16 comprising periodically rotating the machine yoke 180 degrees so that the other support arm is leading along the path of advancement of the finger bit when routing or cutting on the slab.

18. The method of claim 16 wherein at least one shaft is connected to the machining head, said shaft being axial with the A-axis and supported by at least one of the support arms of the machine yoke.

19. The method of claim 18 comprising a second actuator supported by the machine yoke and connected to the at least one shaft and controller, said second actuator configured to rotate the machining head along the A-axis into a bevel routing or cutting position on the slab.

20. The method of claim 16 comprising a third actuator supported by the frame and connected to the bridge and carriage and said controller, said third actuator configured to drive the bridge and carriage during routing or cutting on the slab.
